(19) United States
(12) Patent Application Publication
(10) Pub. No.: US 2026/0227561 A1
(43) Pub. Date: Aug. 6, 2026

(54) GRATING FOR LOW REFLECTION WAVEGUIDE WITH HIGH DISPLAY PERFORMANCE

(71) Applicant: GOOGLE LLC, Mountain View, CA (US)

(72) Inventors: Qinglan Huang, Mountain View, CA (US); Thomas Hoekman, Redwood City, CA (US)

(21) Appl. No.: 19/045,176

(22) Filed: Feb. 4, 2025

(51) Int. Cl. F21V 8/00; G02B 27/00; G02B 27/01

(52) U.S. Cl. CPC G02B 6/0016; G02B 6/0036; G02B 27/0018; G02B 27/0172; G02B 2027/0178

(57) ABSTRACT

A waveguide include at least one one-dimensional (1D) grating disposed at the waveguide. The 1D grating includes a periodic structure defined along a single axis, the periodic structure including alternating regions of differing refractive indices. The 1D grating also includes a plurality of high-refractive-index regions within each period of the periodic structure. In another configuration, the waveguide includes at least one two-dimensional (2D) grating disposed at the waveguide. The 2D grating includes a lattice structure defined along a first axis and a second axis perpendicular to the first axis, the lattice structure comprising alternating regions of differing refractive indices. The 2D grating also includes a plurality of high-refractive-index regions within each unit cell of the lattice structure.

### BACKGROUND

Waveguides are a component in a wide range of optical systems, including augmented reality and virtual reality displays, where they guide light from a source to a user’s eye while maintaining transparency for viewing the external environment. Diffractive gratings, often used in these systems, play a role in efficiently coupling and manipulating light within the waveguide. These gratings are frequently fabricated from high-refractive-index materials, such as titanium dioxide (TiO₂), due to their ability to achieve compact designs and high diffraction efficiency. However, the optical properties of high-refractive-index gratings present challenges, particularly with reflection at the waveguide surface. This reflection affects the overall optical performance and visual experience in applications requiring high transparency and low stray light.

### SUMMARY OF EMBODIMENTS

In accordance with one aspect, a waveguide includes at least one one-dimensional (1D) grating disposed at (e.g., on or within) the waveguide. The 1D grating includes a periodic structure having periods defined along an axis, the periodic structure including alternating regions of differing refractive indices, and a plurality of first regions, having a first refractive index, within each period of the periodic structure.

In at least some embodiments, the periodic structure further includes at least one second region, having a second refractive index lower than the first refractive index, disposed between the plurality of first regions within each period.

In at least some embodiments, the plurality of first regions is arranged to form doubled grating lines within each period.

In at least some embodiments, the 1D grating is disposed at an interface between two layers of differing refractive indices, each of the two layers configured to guide light through total internal reflection.

In accordance with another aspect, at least one two-dimensional (2D) grating disposed at the waveguide. The 2D grating includes a lattice structure defined along a first axis and a second axis perpendicular to the first axis. The lattice structure includes alternating regions of differing refractive indices. The 2D grating also includes a plurality of first regions, having a first refractive index, within each unit cell of the lattice structure.

In at least some embodiments, the lattice structure further includes at least one second region, having a second refractive index lower than the first refractive index, disposed between the plurality of first regions within each unit cell of the lattice structure.

In at least some embodiments, the plurality of first regions is configured in one of a rectangular, oval, or inverse-designed freeform shape.

In at least some embodiments, the lattice structure is configured to diffract light predominantly in a single direction.

In at least some embodiments, the lattice structure includes a transition in refractive index between the plurality of first regions and second regions of lower refractive index within each unit cell.

In a further aspect, near-eye display device includes at least one of the waveguides described herein. The near-eye display device includes a support structure, a lens supported by the support structure, the lens implementing the waveguide, and a light engine configured to project display light for incoupling into the waveguide.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of an example display system including a waveguide assembly implementing one or more gratings to achieve low-reflection waveguides with enhanced display uniformity and brightness efficiency across wavelengths in accordance with some embodiments.

FIG. 2 is a diagram of a projection system that projects images directly onto the eye of a user via display light in accordance with some embodiments.

FIG. 3 is a cross-sectional view of a portion of a one dimensional grating in accordance with some embodiments.

FIG. 4 is a cross-sectional view of different configurations of a two dimensional grating in accordance with some embodiments.

### DETAILED DESCRIPTION

Waveguides facilitate the transmission of light while preserving transparency for the user to view their surroundings. One component of these waveguides is diffractive gratings, which are configured to manipulate and guide light efficiently. High-refractive-index materials are commonly used to fabricate these gratings due to their capability to achieve strong diffraction efficiency and compact system configurations. However, the use of high-refractive-index materials introduces challenges, particularly in the form of significant surface reflections that can adversely impact the functionality and visual quality of these optical systems.

Reflections at the waveguide surface, often reaching levels as high as 20% (or more), result in several performance and aesthetic issues. First, high reflection reduces light transmission, leading to undesirable cosmetic performance characterized by diminished brightness and clarity. Second, external light sources, such as ambient lighting, can reflect off the waveguide surface and into the user’s eye, creating distracting glare. Finally, stray light caused by internal reflections within the optical stack can produce ghost images, further degrading the display quality.

Mitigating these reflections through anti-reflection (AR) coatings is one approach, with the optimal AR coating typically requiring a refractive index matching the material it is applied to. For instance, a silicon dioxide (SiO₂) coating with a refractive index of 1.46, applied at a thickness of one-quarter wavelength, provides an AR solution for waveguides with a refractive index of around 2. However, achieving effective AR coatings in the context of high-refractive-index gratings is complex due to the need for high-index contrast to maintain grating efficiency. For example, gratings made from TiO₂ (refractive index ~2.4) benefit from their high index contrast relative to air (refractive index ~1.0) for strong diffraction performance, but this same contrast exacerbates surface reflections.

Encapsulating the grating to address reflection issues introduces additional trade-offs. Encapsulation can reduce the angular and wavelength bandwidth of the grating, leading to non-uniform display performance and lower overall efficiency. Alternatively, using lower-index resin coatings can improve display brightness and uniformity but may not achieve the same level of reflection reduction as a dedicated AR coating. Balancing grating performance, reflection control, and display uniformity presents a significant challenge due to the conflicting requirements of high diffraction efficiency, minimal surface reflections, and consistent optical performance across the display.

As such, the following describes embodiments of systems and methods for implementing advanced grating (e.g., metagrating) configurations in head-wearable display (HWD) devices to achieve low-reflection waveguides with enhanced display uniformity and brightness efficiency across wavelengths. For example, in at least some embodiments, a one-dimensional (1D) grating includes doubled grating lines per wavecycle, which reduces reflectivity to at least less than 2% while enhancing red wavelength efficiency through resonance modes. In another embodiment, a two-dimensional (2D) grating lattice diffracts light predominately in a single direction, with various shapes, such as rectangles or ovals, optimized for diffraction control. In other embodiments, further optimization of the 2D rectangular lattice involves tuning fill factors along horizontal and vertical axes, which enables a wide range of diffraction efficiencies to achieve an average on-axis reflectivity of at least 1.7%. These grating configurations described herein address challenges of reflection, efficiency, and wavelength uniformity, significantly enhancing optical performance in HWD systems. In at least some embodiments, the gratings described herein are metagratings, which include periodic structures with subwavelength features in their unit cells that enable precise manipulation of light through diffraction, reflection, or transmission for tailored optical functionalities. However, other types of gratings are applicable as well.

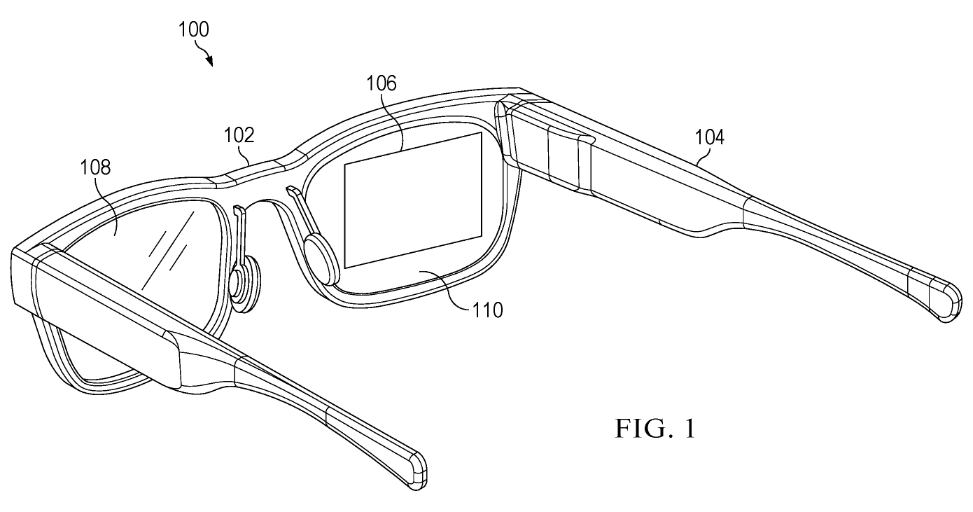

FIG. 1 illustrates an example display system 100 having a support structure 102 that includes an arm 104, which houses a projection system configured to project display light representative of images toward the eye of a user, such that the user perceives the images as being displayed in an FOV area 106 of a display at one or both of lens elements 108, 110. In the depicted example, the display system 100 is an HWD or other near-eye display (NED) that includes a support structure 102 configured to be worn on the head of a user and has a general shape and appearance of an eyeglasses frame or sunglasses frame. The support structure 102 contains or otherwise includes various components to facilitate the projection of such images toward the eye of the user, such as a projector (e.g., optical engine) and a waveguide. In at least some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth interface, a Wi-Fi interface, and the like. Further, in at least some embodiments, the support structure 102 includes one or more batteries or other portable power sources for supplying power to the electrical components of the display system 100. In at least some embodiments, some or all of these components of the display system 100 are fully or partially contained within an inner volume of support structure 102, such as within the arm 104 in a region of the support structure 102. It should be noted that while an example form factor is depicted, it will be appreciated that in other embodiments, the display system 100 may have a different shape and appearance from the eyeglasses frame depicted in FIG. 1.

One or both of the lens elements 108, 110 are used by the display system 100 to provide, for example, an extended reality (XR) display in which rendered graphical content can be superimposed over or otherwise provided in conjunction with a real-world view as perceived by the user through the lens elements 108, 110. Display light used to form a perceptible image or series of images is projected by a light engine of the display system 100 and routed through a waveguide incorporating one-dimensional (1D) and two-dimensional (2D) grating, such as a metagrating or a different type of grating. These gratings are configured to reduce surface reflection and enhance diffraction efficiency, resulting in improved brightness uniformity and color fidelity across the display. The waveguide includes incoupling and outcoupling elements that use the grating structures to direct and modulate the display light onto the user’s eye, allowing the user to view the image within the FOV of the display system 100.

For example, the light engine emits display light representative of an image such that the display light forms an exit pupil near the light engine output. The display light then travels to the incoupler of the waveguide. In at least some embodiments, the incoupler features grating configurations to enhance coupling efficiency while minimizing reflection losses. These gratings include 1D gratings with doubled grating lines per wavecycle, achieving reflectivity of at least less than 2%, which significantly reduces wavelength roll-off, particularly in red wavelengths. Additionally, 2D gratings are configured to diffract light in specific directions using lattice structures with optimized fill factors and shapes, such as rectangular or oval forms, to further enhance efficiency and control.

After receiving the display light, the incoupler directs the light into the body of the waveguide. The light propagates through the waveguide via total internal reflection (TIR), partial internal reflection (PIR), or both, until it reaches an exit pupil expander (EPE). The EPE, in at least some embodiments, includes one or more grating structures as described herein to increase the eyebox size by replicating the exit pupil, ensuring a wider and more uniform viewing area for the user. From the EPE, the display light continues to propagate through the waveguide until it is directed by the outcoupler toward the user’s eye. In at least some embodiments, the outcoupler also features gratings having one or more configurations described herein that ensure minimal reflection while maximizing the transmission of display light to the user.

In some embodiments, the light engine is a digital light processing-based projector, a micro-projector, a scanning laser projector, or any combination of a modulative light source such as a laser or one or more LEDs and a dynamic reflector mechanism such as one or more dynamic scanners or digital light processors. In some embodiments, the projector includes multiple laser diodes (e.g., a red laser diode, a green laser diode, and/or a blue laser diode). The light engine is communicatively coupled to the controller and a non-transitory processor-readable storage medium or a memory that stores processor-executable instructions and other data that, when executed by the controller, cause the controller to control the operation of the light engine.

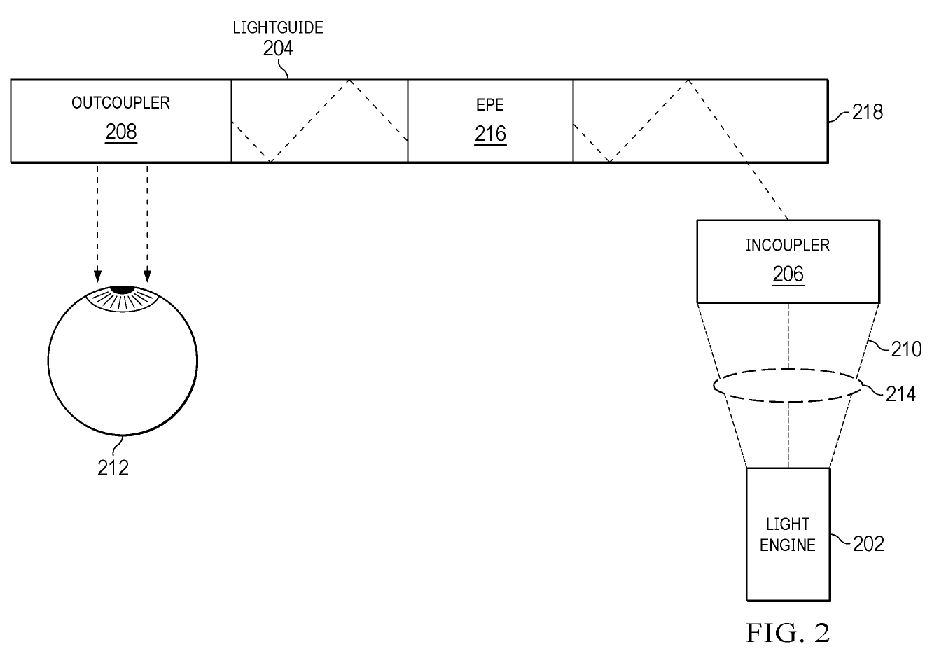

FIG. 2 illustrates a simplified block diagram of a projection system 200 that projects images directly onto the eye of a user via display light. The projection system 200 includes a light engine 202 and a waveguide 204. In one example, the waveguide 204 is a lightguide (e.g., a combiner) that transfers light from an incoupler (e.g., incoupler 206) to an outcoupler 208. The waveguide 204 can utilize one or more mechanisms, such as total internal reflection (TIR), partial internal reflection (PIR), specialized filters, diffractive structures, and/or reflective surfaces. In some display applications, the light transferred through the waveguide 204 is a collimated image, and the waveguide replicates and transfers the collimated image to the user’s eye. In at least some embodiments, the projection system 200 is implemented in a head-worn display (HWD), near-eye display (NED), or other display systems, such as the display system 100 illustrated in FIG. 1.

The light engine 202 includes one or more display light sources configured to generate and output display light 210 (e.g., visible display light such as red, blue, and green display light and/or non-visible display light such as infrared display light) representing an image. In at least some embodiments, the light engine 202 is coupled to a driver or other controller (not shown), which controls the timing of emission of display light from the display light sources of the light engine 202 in accordance with instructions received by the controller or driver from a computer processor coupled thereto to modulate the display light 210 to be perceived as images when output to the retina of an eye 212 of a user. For example, during the operation of the projection system 200, multiple display light beams having respectively different wavelengths are output by the display light sources of the light engine 202, then combined via a beam combiner (not shown), before being directed to the eye 212 of the user. The light engine 202 modulates the respective intensities of the display light beams so that the combined display light reflects a series of pixels of an image, with the particular intensity of each display light beam at any given point in time contributing to the amount of corresponding color content and brightness in the pixel being represented by the combined display light at that time. In at least some embodiments, the light engine 202 forms an exit pupil 214 near or at its output, with a shape (e.g., circular) and size (e.g., diameter) dependent on the configuration of the light engine 202. The display light 210 then travels to the waveguide 204, which includes or is otherwise connected to an incoupler 206, exit pupil expander (EPE) 216, and outcoupler 208.

The incoupler 206 is configured to efficiently direct display light 210 into the body 218 of the waveguide 204. In at least some embodiments, the incoupler 206 incorporates one-dimensional (1D) and/or two-dimensional (2D) grating structures (e.g., metagrating structures) to optimize diffraction efficiency and minimize reflection losses. For example, 1D gratings, in at least some embodiments, are configured with doubled grating lines within a single wavecycle to reduce reflectivity to less than 2%, while supporting higher efficiency for red wavelengths. Similarly, 2D grating configurations, in at least some embodiments, include lattice structures (e.g., rectangular or oval shapes) configured to diffract light in specific directions, further enhancing brightness and uniformity. These grating-based incouplers significantly improve light coupling efficiency compared to conventional configurations.

After receiving the display light 210, the incoupler 206 directs the light into the body 218 of the waveguide 204, where it propagates via TIR, PIR, or both. The light then reaches the EPE 216, which, in at least some embodiments, includes one or more grating structures configured to increase the eyebox size by replicating the exit pupil into multiple beams. This enables a wider and more uniform viewing area for the user. From the EPE 216, the display light continues through the waveguide 204 until it is directed out by the outcoupler 208. The outcoupler 208 incorporates similar grating structures to ensure minimal reflection and high transmission of light to the eye 212 of the user. In at least some embodiments, additional optical components, such as polarization films, are included to further optimize image quality by reducing ghosting or enhancing uniformity. For example, a polarization film may be disposed on the outcoupler 208 to polarize the display light 210.

In at least some embodiments, the projection system 200 also includes additional components such as turning prisms to redirect display light or adjust the optical path. These components, along with the advanced grating configurations, enable precise control over the propagation and delivery of display light, ensuring an optimal user experience in extended reality (XR) applications.

As described above, one or more gratings are implemented in a display device, such as the display device 100 of FIG. 1, to significantly reduce surface reflections and enhance the efficiency and uniformity of display light across various wavelengths. In at least some embodiments, the one or more gratings are metagratings. A metagrating is a diffractive structure composed of subwavelength features that interact with incident light to achieve desired optical effects. Unlike conventional gratings, which typically consist of periodic lines or grooves, metagratings utilize complex patterns and configurations to control the phase, amplitude, and direction of diffracted light with high precision. This enables the creation of optical elements with tailored diffraction efficiencies, reduced unwanted reflections, and enhanced wavelength-specific performance. Metagratings can be one-dimensional (1D) or two-dimensional (2D), each offering unique advantages in managing light propagation within optical systems. By leveraging metagrating technology, the display device achieves improved brightness, color fidelity, and overall visual performance for applications in augmented reality, virtual reality, and other extended reality systems. It should be understood that the embodiments described herein are applicable to other types gratings as well.

In at least some embodiments, a 1D grating (e.g., a 1D metagrating) implementation is implemented and configured to minimize surface reflections while maintaining high diffraction efficiency. The 1D grating includes doubled grating lines within a single wave cycle (i.e., one period), as illustrated in FIG. 2 described below. These doubled grating lines are formed by two distinct high-refractive-index regions within each period, separated by broader low-refractive-index regions. This configuration introduces various enhancements and improvements, such as a resonance mode for higher efficiency in red wavelengths and reduced reflectivity (< 2%).

For example, the doubled grating lines facilitate resonance modes that specifically enhance the diffraction efficiency for red wavelengths. This is advantageous because traditional binary gratings exhibit significant reflectivity (~ 20%) at red wavelengths, leading to a noticeable roll-off in red color performance. By supporting resonance modes, the 1D grating ensures that red light is efficiently diffracted into the desired direction, thereby maintaining color fidelity and brightness. The precise structural parameters of the high-refractive-index regions, including their width, height, and spacing, are configured to align with the resonant conditions required for efficient light coupling in the red spectrum.

Also, the innovative 1D grating configuration achieves a reflectivity of less than 2%, a substantial improvement over the approximately 20% reflectivity observed in conventional binary gratings. This reduction in surface reflection mitigates several issues, including improved transmission of display light through the waveguide, minimized glare from environmental light sources, and elimination of ghost images caused by stray light reflections within the optical stack. This performance is further enhanced by the smooth refractive index transitions within the grating structure, which minimize scattering losses and suppress unwanted diffraction orders. These transitions help to ensure that the majority of incident light is directed into the desired diffraction modes, improving overall efficiency.

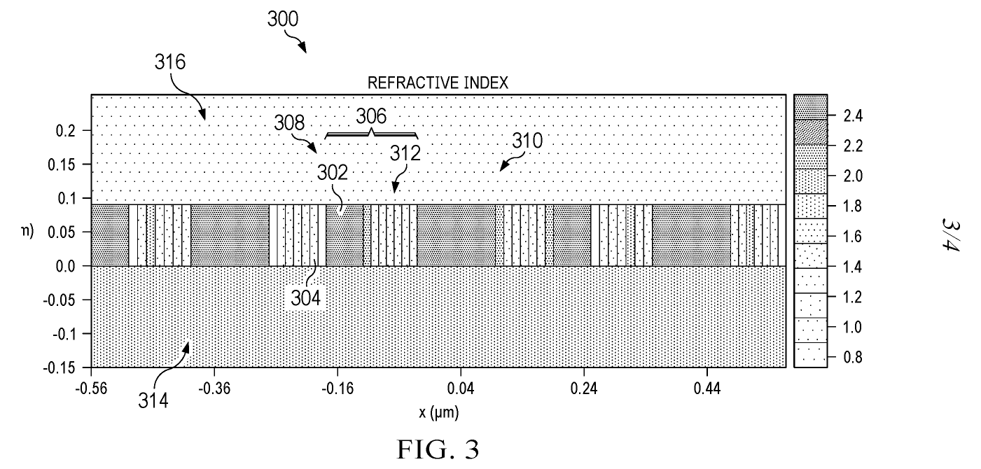

FIG. 3 provides a detailed visualization of the 1D grating structure. In particular, FIG. 3 shows a cross-sectional view of a 1D grating structure 300 (e.g., a 1D metagrating structure), illustrating the refractive index distribution along the x and z axes. The grating lines are the alternating regions of high refractive indices 302 and low refractive indices 304 located near z = 0 (the interface between two major layers). For clarity, only one of the high refractive index grating lines 302 and one of the low refractive index grating lines 304 are labeled in FIG. 3. Each period 306 along the x-axis includes two high-refractive-index regions 308, 310 separated by broader low-refractive-index regions 312.

Within the low-refractive-index regions 312, FIG. 3 shows a transition in refractive index, represented as intermediate refractive index modulations that appear as different patterned regions. These intermediate structures act as fine-tuning elements to optimize the grating’s performance by enhancing resonance modes, suppressing unwanted reflections, and reducing scattering. The plurality of high-refractive-index regions 308, 310 within each period 306 are arranged to form doubled grating lines, separated by the broader low-refractive-index regions 312. These doubled grating lines enhance diffraction efficiency by supporting resonance modes and minimizing unwanted reflections, while the refractive index transitions between the high-refractive-index and low-refractive-index regions further refine light coupling and propagation efficiency.

The alternating refractive index pattern creates a layered structure at the interface of two bulk regions 314, 316. The lower layer 314 (z < 0) has a uniform high-refractive-index material (≈ 2.4) and the upper layer 316 (z > 0) has a uniform low-refractive-index material (≈ 1.4). Each of these layers is configured to guide light through total internal reflection or partial internal reflection, enabling efficient propagation of light within the waveguide. The grating itself includes alternating high and low index regions near z = 0, with a periodicity of approximately 0.2 micrometers (μm). The doubled grating lines 308, 310 and the intermediate refractive index modulations 312 collectively enhance the interaction of light with the grating, enabling precise control over diffraction efficiency and reflectivity.

The 1D grating’s ability to lower reflectivity while enhancing wavelength-specific efficiency makes it a useful component in achieving uniform brightness and high-quality image display in HWDs. By integrating this advanced structure, the display system overcomes common issues such as color roll-off, glare, and ghosting, delivering a superior viewing experience. The structural sophistication of the 1D grating enables precise control over light propagation and ensures that the waveguide performs efficiently across a broad range of wavelengths.

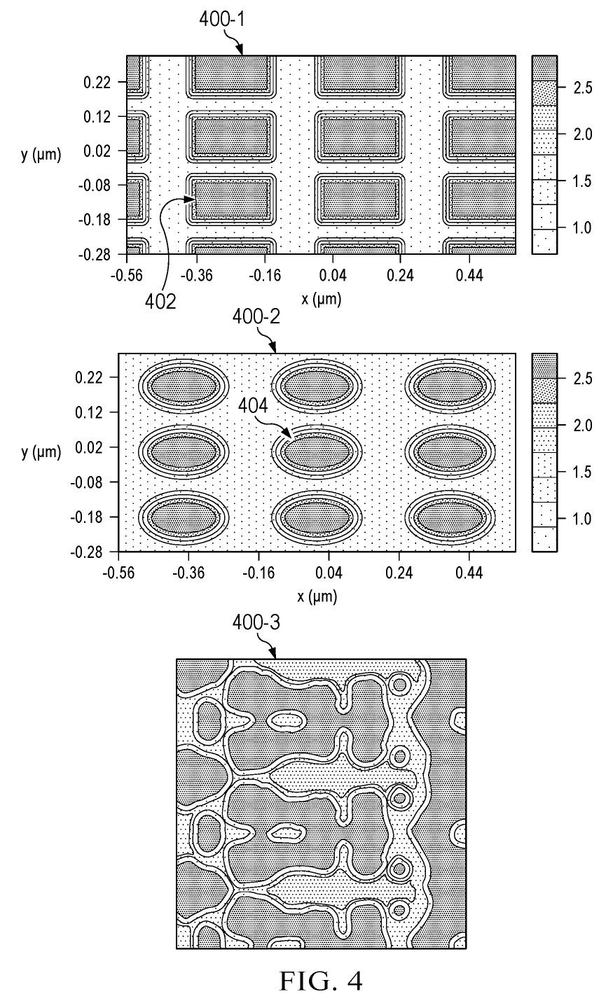

The 2D grating configuration (e.g., 2D metagrating configuration) builds upon the advantages of the 1D configuration by providing additional control over light propagation within the waveguide. As shown in FIG. 4, the 2D grating 400 (illustrated as 2D metagrating 400-1 to 2D metagrating 400-3) includes a lattice structure comprising a repeating arrangement of unit cells, each unit cell forming the fundamental building block of the lattice. The unit cells are defined by their periodicities along the x and y axes (P x and P y, respectively). In at least some embodiments, the lattice periodicities are configured such that P x = OC_Period and P y = OC_Period/2, resulting in an asymmetrical unit cell. This asymmetry reduces cross-talk and enhances image clarity by directing light along the x-axis. The 2D grating structure is further enhanced by incorporating various lattice configurations, including rectangular, oval, and inverse-designed freeform shapes, each offering unique benefits in diffraction efficiency, reflectivity reduction, and light modulation. The periodic structure includes a transition in refractive index between high-refractive-index regions and lower-refractive-index regions within each unit cell of the lattice, enabling effective diffraction and precise light control.

In at least some embodiments, each unit cell includes alternating regions of differing refractive indices arranged in various lattice configurations, such as rectangular, oval, or inverse-designed freeform shapes. The shape and refractive index distribution within the unit cells are configured to optimize diffraction efficiency, reduce reflectivity, and enable precise light modulation. These unit cells repeat across the lattice to form the 2D grating structure 400, providing enhanced control over light propagation and directional diffraction.

The 2D grating 400-1 having a rectangular configuration features a grid of rectangular elements 402 defined by their width, height, and periodic spacing along the x and y axes. This configuration allows for independent tuning of the fill factor along both axes, enabling precise control of diffraction efficiency for specific wavelengths and angles of incidence. By adjusting the fill factor, the rectangular lattice can accommodate a wide range of optical requirements, ensuring optimal performance across varying viewing angles and wavelength bands. Additionally, this configuration achieves consistent low reflectivity, maintaining an average on-axis reflectivity of, for example, at least 1.7% across all fill factor combinations.

The 2D grating 400-2 having an oval configuration, introduces elliptical elements 404 arranged in a grid. The elongated shape of the ovals provides additional degrees of freedom for tailoring optical properties, particularly in polarization-sensitive applications. By adjusting the aspect ratio of the ovals (length-to-width ratio), the diffraction efficiency can be optimized for light polarized along specific axes. Furthermore, the smoother edges of the ovals reduce scattering losses compared to the sharp edges of rectangular elements, allowing for more efficient light propagation through the waveguide.

The 2D grating 400-3 having an inverse-designed freeform configuration, represents a computationally optimized pattern that departs from traditional geometric shapes. Generated using inverse design algorithms, this highly irregular lattice is tailored to maximize specific optical performance metrics, such as diffraction efficiency, reflectivity suppression, and light coupling. The resulting structure enables control over complex diffraction patterns, allowing for precise modulation of light across multiple diffraction orders. Together, these 2D configuration complement the 1D grating configuration by enabling enhanced control over light propagation, improved brightness, and reduced artifacts, ensuring optimal performance in head-mounted displays.

In addition to the embodiments described above, one or more of the grating configurations are also applicable to non-binary grating structures, including advanced multilayer configurations, such as bilayer metagrating structures. For instance, a bilayer structure can incorporate an overlapping Δ/N configuration (where Δ represents the grating period and N is the number of layers) on top of the nominal grating structure used for light extraction. This configuration allows for precise control over the diffraction behavior by leveraging the additional degrees of freedom introduced by the bilayer configuration. This bilayer structure enhances the ability to manipulate resonance modes and adjust phase-matching conditions, thereby improving diffraction efficiency and reducing unwanted reflectivity.

For example, in cases where N = 2, the upper layer of the bilayer structure can be configured with a slightly modified periodicity or refractive index profile to optimize light coupling for specific wavelength bands. This layered approach not only improves the angular and wavelength bandwidth of the grating but also mitigates cross-talk between adjacent diffraction orders. The overlapping Δ/N design creates a gradient refractive index profile that smooths the transitions between high- and low-index regions, further suppressing surface reflections and scattering losses.

As such, the integration of one or more of the 1D grating configuration or the 2D grating configurations provides a comprehensive approach to optimizing light control within waveguides for advanced optical systems. The 1D grating leverages doubled grating lines to enhance resonance modes, significantly improving diffraction efficiency for red wavelengths and reducing surface reflectivity to less than 2%. This ensures superior color fidelity, brightness, and minimal visual artifacts. Complementing this, the 2D grating introduces directional diffraction control and customizable lattice configurations, such as rectangular, oval, and inverse-designed freeform shapes. These 2D configurations enable precise tuning of diffraction efficiencies, consistent low reflectivity, and reduced scattering, further enhancing performance across a broad range of wavelengths and viewing conditions. Individually, or in combination, the 1D and 2D grating technologies deliver improved optical performance, reduced artifacts, and improved display uniformity, making them advantageous for applications in HWDs and other near-eye systems.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is, therefore, evident that the particular embodiments disclosed above may be altered or modified, and all such variations are considered within the scope of the disclosed subject matter. Accordingly, the protection sought herein is as set forth in the claims below.

What is claimed is:

1. A waveguide, comprising:
at least one one-dimensional (1D) grating disposed at the waveguide, the 1D grating comprising:
a periodic structure having periods defined along an axis, the periodic structure including alternating regions of differing refractive indices; and
a plurality of first regions, having a first refractive index, within each period of the periodic structure.

2. The waveguide of claim 1, wherein the periodic structure further comprises:
at least one second region, having a second refractive index lower than the first refractive index, disposed between the plurality of first regions within each period.

3. The waveguide of claim 1, wherein the plurality of first regions is arranged to form doubled grating lines within each period.

4. The waveguide of claim 1, wherein the 1D grating is disposed at an interface between two layers of differing refractive indices, each of the two layers configured to guide light through total internal reflection.

5. The waveguide of claim 1, wherein the periodic structure includes a transition in refractive index between the plurality of first regions and second regions of lower refractive index between the plurality of first regions.

6. A near-eye display device comprising the waveguide of claim 1, and further comprising:
a support structure;
a lens supported by the support structure, the lens implementing the waveguide; and
a light engine configured to project display light for incoupling into the waveguide.

7. A waveguide, comprising:
at least one two-dimensional (2D) grating disposed at the waveguide, the 2D grating comprising:
a lattice structure defined along a first axis and a second axis perpendicular to the first axis, the lattice structure comprising alternating regions of differing refractive indices; and
a plurality of first regions, having a first refractive index, within each unit cell of the lattice structure.

8. The waveguide of claim 7, wherein the lattice structure further comprises:
at least one second region, having a second refractive index lower than the first refractive index, disposed between the plurality of first regions within each unit cell of the lattice structure.

9. The waveguide of claim 7, wherein the plurality of first regions is configured in one of a rectangular, oval, or inverse-designed freeform shape.

10. The waveguide of claim 7, wherein the lattice structure is configured to diffract light predominantly in a single direction.

11. The waveguide of claim 7, wherein the lattice structure comprises a transition in refractive index between the plurality of first regions and second regions of lower refractive index within each unit cell.

12. A near-eye display system comprising the waveguide of claim 7, and further comprising:
a support structure;
a lens supported by the support structure, the lens implementing the waveguide; and
a light engine configured to project display light for incoupling into the waveguide.
